(19) United States
(12) Patent Application Publication
(10) Pub. No.: US 2004/0233849 A1
(43) Pub. Date: Nov. 25, 2004

(54) Methodologies, systems and computer readable media for identifying candidate relay nodes on a network architecture

(76) Inventor: Eric B. Cole, Leesburg, VA (US)

Correspondence Address: TIMOTHY J MARTIN, PC, 9250 W 5TH AVENUE, SUITE 200, LAKEWOOD, CO, 80226, US

(21) Appl. No.: 10/445,367

(22) Filed: May 23, 2003

(51) Int. Cl. H04L 12/26

(52) U.S. Cl. 370/238; 370/252

(57) ABSTRACT

A computerized method, computer-readable medium and a monitoring system are each provided for determining whether a selected computer system is a candidate relay node used to route network traffic from an origin to a destination computer system. Particularly suited for identifying relay sites used by an attacker during a relay attack, the invention in its various forms provides for monitoring inbound and outbound network traffic associated with a computer system of interest to determine if there is a recurring correlation therebetween which indicates that the system is used to repeatedly forward inbound network traffic from a particular predecessor node on a network architecture to a particular successor node on the network architecture. If such a correlation recurs with a selected frequency, the computer system of interest is identified as a candidate relay site.

### FIELD OF THE INVENTION

The present invention generally relates to the field of intrusion detection and more particularly concerns computer readable media, methodologies and systems for use in identifying candidate relay sites employed by an attacker to implement a relay attack across a network infrastructure.

### BACKGROUND OF THE INVENTION

Networked computer systems are susceptible to a wide range of vulnerabilities, particularly those connected to the global Internet. Experience has shown that such systems are almost always susceptible to some kind of attack since not all attacks can be prevented. Once a computer system has been successfully infiltrated, an attacker can make unauthorized use of its resources or interfere with the intended use of those resources, among other things. Cyber attack studies have shown that most attackers actually perform a series of unsuccessful attacks before eventually finding a successful one through persistence. Since attackers will generally be unsuccessful in initially gaining access to a site, the sooner a targeted victim can determine an attacker's identity, the sooner it will be able to take appropriate action to minimize potential damage. It can therefore be important, particularly for companies which put critical systems with sensitive data on the Internet, to protect information from attack. Unfortunately, in more instances than perhaps many companies would like to admit, attacks are successful and cause huge monetary loss to a company. In such circumstances, it is imperative that a company determine the attacker's identity so the company can take appropriate legal action and prevent future infiltration.

Unfortunately, ascertaining an attacker's identity is oftentimes an exceedingly difficult task since most attackers will not directly break into a site from their computer or network, as this would be readily traceable. For example, if the two systems are directly connected via a TCP connection, the source and destination IP addresses would be clearly listed in the TCP/IP headers, and it will become trivial for a system administrator to sniff the packets and determine the address of the attacker. For this reason, spoofing attacks or relay attacks are often employed to gain unauthorized access to systems. In a spoofing attack, an attacker sends a packet to a victim's system and attaches a false source address. These attacks are primarily used for denial of service attacks, to hide the IP address of the actual attacker. The problem with spoofing attacks, however, is that the victim replies back to the spoofed source so the attacker does not receive any return packets. Since the attacker receives no replies, this type of an attack is not appropriate for accessing a system remotely, installing backdoors, gaining access and the like.

In situations where an attacker wants to actually connect to a remote host but does not desire the victim to known the true IP address of the attacker, relay systems are predominately employed. Here, an attacker does not attack a site directly, but rather uses one or more relay sites to bounce traffic through, thereby making it exceedingly difficult to determine the attacker's origin location. To utilize relays, an attacker breaks into a site and initially installs relay software, such as Netcat or the like, which operates to receive traffic from a given IP address and automatically open up a separate TCP/IP connection to another IP address and then forward the data on to that IP address. Several relays can be set up in this manner to make it even more difficult to trace back the IP of the actual attacker. Accordingly, once an attacker has the relays established, he/she would connect to the first relay, which automatically establishes a connection to a second relay, etc., and eventually connect to the victim's computer system. Now, when an administrator looks at the TCP/IP packet headers to determine the source of the attack, it is not the attacker's IP, but rather the IP of some intermediary relay site that was compromised by the attacker. Thus, for example, if an attacker bounces through three relay sites, there are six TCP/IP sessions that have to be traced back to determine the IP of the actual attacker. This is by no means a trivial task and can be exceedingly difficult to perform. As such, by looking solely at the TCP/IP headers, the victim network generally has no idea of knowing whether the source header corresponds to an actual attacker or a compromised relay site.

Research has been conducted to detect relays, but most of this research relies upon producing fingerprints or signatures of the data, and then looking for certain data at various other points on the Internet. This requires access to critical points on a network infrastructure and sometimes very complex analysis. Accordingly, there remains a need to provide a new and improved approach to identifying candidate relay sites, as this would assist in tracing back the identify of an attacker's computer system, and it has been found that an intuitive approach can be implemented to ultimately pinpoint an attacker's identity by taking advantage of the inherent and immediate nature of how relays work. The present invention is particularly directed to meeting these needs.

### SUMMARY OF THE INVENTION

It is an object of the present invention to provide a new and improved computerized method for determining if a selected computer system is a candidate relay node used to route network traffic between an origin and destination computer systems.

Another object of the present invention is to provide such a computerized methodology which is particularly suitable for identifying each relay site used by an attacker during a relay attack for the purpose of routing network traffic between an attacking computer system and a victim computer system.

It is yet another object of the present invention to provide a computer-readable medium having computer executable instructions for performing such methodologies in order to identify candidate relay sites.

A further object of the present invention is to provide methodologies which are particularly suitable for ascertaining whether a dedicated client compute system, or a dedicated host computer system, is used as a relay node during a relay attack.

A still further object of the present invention is to provide a monitoring system for ascertaining relay nodes used for routing network traffic from a origin computer system to a destination computer system.

In accordance with these objectives, the present invention in one sense relates to a computerized method for determining whether a selected computer system is a candidate relay node used to route network traffic from an origin computer system to a destination computer system. Broadly, the network traffic comprises a stream of packets each having an associated header portion which contains addressing information for the respective packet, and a data portion which includes a data payload. More specifically, each packet is routed between an origin and destination computer system along an associated communication pathway according to a selected communication protocol, such as the TCP/IP protocol suite. Where the TCP/IP protocol suite is employed for routing the stream of packets in a packet switched network, the header portion of each packet necessarily includes, among other things, a source field that identifies a source IP address for a predecessor node in the packet's associated communication pathway, and a destination field that identifies a destination IP address for a successor node and the packet's associated communication pathway.

One implementation of the computerized method can be implemented on any suitable packet-switching network, such that it is not limited to use on an open system network employing the TCP/IP protocol suite. This broad methodology is intended to encompass the detection of a candidate relay site for any appropriate computer system, such as a web server, a DNS server, a client work station, a router or the like, which resides on a network architecture. The method broadly comprises comparing the addressing information contained within the associated header portion of a respective outbound packet that is transmitted by the selected computer system with the addressing information contained within the associated header portion of each inbound packet, if any, having the same data payload that was previously received by the computer system during a preceding interval of time in order to determine if a match exists between the addressing information. The preceding interval of time can be any suitable period that is adequate to reliable make such a comparison. A three (3) minute interval has been found to be is suitable since this comports with TCP/IP retransmission rules. When comparing the addressing information contained within inbound and outbound packets, it is preferred to compare the associated source address of each respective outbound packet to the associated destination address of each inbound packet previously received by the selected computer system in order to determine an existence or absence of a match therebetween. Absence of a match indicates that the computer system has modified the addressing information contained within the packet's header, a function generally not performed with networked computer systems such as web servers, DNS servers, routers, etc. Accordingly, if absence of a match occurs with a selected threshold frequency, then the selected computer system is identified as a candidate relay node. For purposes of this, the selected threshold frequency may be any appropriate frequency deemed by an administrator, investigator or the like to be sufficient for indicating relaying activity as opposed to some other type of activity outside the systems normal operation, e.g. network testing. For example only, a frequency threshold of approximately 20 times in a three minute period may be sufficient for some purposes, while in other situations even a single occurrence of a match may be sufficient to raise an alert. Accordingly, the particular frequency threshold can be fixed or adjustable to any desirable level or range without limitation.

Another embodiment of the computerized method of the present invention is particularly adapted for detecting relays in a TCP/IP packet-switching network. According to this method, inbound and outbound packets associated with the selected computer system are monitored, preferably with any appropriate sniffer program such as tcpdump, windump, ethereal, sniffit, or the like, and the associated header portion and data portion for each inbound packet that is received by the selected computer system is stored into a first memory region for a selected storage period, thereby to generate a time-dependent compilation of inbound packet data. This first memory region may be a first database residing on the selected computer system. For each of a plurality of outbound packets that are transmitted by the selected computer system, a comparison is made between the source IP address of the respective outbound packet and the destination IP address of each inbound packet stored in the first database which has the identical data payload, if any. If such a match exists, then a corresponding event log is stored into a second memory region, such as a second database associated with the selected computer system. For purposes of making such a comparison, a first SQL script can be executed against the first database. A second SQL script can be executed against the second database to ascertain if such a match occurs with a selected frequency, as that discussed above. If this occurs, then the selected computer system is identified as a candidate relay.

An alternative embodiment of the method of the present invention involves identifying each of a plurality of relay sites used by an attacker during a relay attack for the purpose of routing network traffic between an attacking computer system and a victim computer system. According to this version of the methodology, a first computer system of interest that resides on a network architecture is initially identified. Inbound and outbound network traffic associated with the selected computer system of interest is monitored in order to ascertain a frequency at which inbound traffic received by the computer system of interest from a particular predecessor computer system is subsequently transmitted by the computer system of interest to a particular successor computer system. If this occurs at a frequency which exceeds a predetermined threshold then the computer system of interest is identified as a candidate relay site. The predecessor computer system and the successor computer system are each also identified as a next selected computer system of interest, such that the operation of monitoring inbound and outbound network traffic can be repeated for each newly identified predecessor and successor computer system. In this manner, an approach is provided to hopefully trace back, ultimately to attacking computer system, each relay site which is used to route the network traffic between the attacking computer system and the victim computer system.

Particular embodiments of the method of the present invention can be employed to determine whether a dedicated client computer system or a dedicated host computer system is employed as a relay site. With respect to determining whether a dedicated client computer system is used as a relay, the method comprises storing onto the client computer system computer executable instructions for sniffing network traffic associated with the client computer system during a selected monitoring period, ascertaining a frequency, if any, at which the client computer system receives connection requests from another computer system on the network architecture, and controlling an output device to display associated output if the ascertained frequency exceeds a predetermined threshold. Where a dedicated host computer system is concerned, this methodology is the same with one exception. Here, the network traffic is sniffed for the purpose of ascertaining a frequency, if any, at which the host computer system initiates connection requests to another computer system on the network architecture.

The present invention also relates to a computer-readable medium having executable instructions. The executable instructions preferably perform a method which comprises monitoring inbound and outbound network traffic associated with a networked computer system, comparing outbound network traffic transmitted by the system to inbound traffic previously received by the system in order to ascertain if there is a recurring correlation therebetween which indicates that the computer system is used to repeatedly forward inbound traffic from a particular predecessor node on a network architecture to a particular successor node on the network architecture. If it is ascertained that such a correlation recurs with a selected frequency, then the executable instructions control an output device to display output indicative of the network computer system being a candidate relay site. Preferably, the executable instructions are operative to store inbound network traffic in a first memory region of the networked computer system for a selected storage period, and are further operative to store an event log into a second memory region of the networked computer system each time such a correlation is ascertained. Preferably also, the executable instructions are operative to query the second memory region according to a selected querying script in order to ascertain if the correlation recurs with the selected frequency. Finally, a monitoring system is provided for ascertaining relay nodes used for routing network traffic from a origin computer system to a destination computer system. This monitoring system comprises a storage device, an output device, a network interface, and a processor programmed to perform the broad methodology discussed above with respect to the computer-readable medium of the present invention.

These and other objects of the present invention will become more readily appreciated and understood from a consideration of the following detailed description of the present invention when taken together with the accompanying drawings which form a part hereof, and in which is shown by way of illustrations specific embodiments for practicing the invention. The leading digit(s) of the reference numbers in the figures usually correlate to the figure number, with the exception that identical components which appear in multiple figures are identified by the same reference numbers. The embodiments illustrated by the figures are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense, and the scope of the present invention is defined only by the appended claims.

### BRIEF DESCRIPTION OF THE DRAWINGS

FIG. 1(a) is a diagrammatic view illustrating routing characteristics between origin and destination computer systems in a non-relaying situation;

FIG. 1(b) illustrates portions of a representative IP packet as it is transmitted along the communication pathway illustrated in FIG. 1(a);

FIG. 2(a) is a diagrammatic view, similar to that of FIG. 1(a), but this time illustrating a situation where relaying is employed to route the network traffic;

FIG. 2(b) illustrates portions of a each IP packet at different stages as it is transmitted along the pre-determined communication pathway represented in FIG. 2(a);

FIG. 3 is a functional block diagram of a representative networked computer system which can be provided with computer software to implement the functions for the trace back system of the present invention in order to ascertain if it is a candidate relay site;

FIG. 4 is a diagrammatic view of illustrating implementation of the trace back software of the present invention on a representative ISP architecture; and

FIG. 5 is a diagrammatic view showing how implementation of the present invention, for example on the ISP architecture of FIG. 3, can facilitate identification of relay sites employed by an attacker who is infiltrating a victim computer system.

### DETAILED DESCRIPTION OF THE EXEMPLARY EMBODIMENTS

The present invention is primarily concerned with new approaches for determining relay sites used to route network traffic between origin and destination computer systems. While there may be a variety of reasons a user would wish to identify those nodes or sites on a network architecture which are used as relays in routing network traffic, it is contemplated that the present invention will primarily benefit investigators in identifying originating computer systems used by attacker/hackers during relay attacks.

In its various forms, the present invention may be implemented on one or more selected computer systems, each of which resides as a node on a selected network architecture, such that it can be referred to as a networked computer system, and which operatively permits data in the form of packets/datagrams to be communicated through the network according to a communication protocol. To this end, each networked computer system minimally includes a network interface, a processor such as a central processing unit (CPU), memory such as a read only memory (ROM), and has I/O capabilities. Accordingly, the computer system(s) could minimally, and without limitation, be any appropriate system utilized on a network infrastructure, common ones of which include work stations, servers (such as DNS servers, web servers, e-mail servers, DHCP servers, etc.), routers and the like. As will be appreciated from the discussion to follow, the manner in which the present invention may be practices can in part be dictated by the particular type of computer system on which it is employed, such as a dedicated client desktop system which is not intended to be receiving connection requests from another computer system, a dedicated host computer system (web servers and the like) which are not intended to be initiating outbound connections to other computer systems on the network architecture. Other aspects of the present invention are perhaps, though, best employed on computer systems, such as DNS servers, which commonly receive and initiate connection requests.

From the description to follow it should also be apparent that the terms “network”, “network architecture” and “network infrastructure” are used interchangeably. These terms broadly contemplate a series of points or nodes interconnected by communication paths. It is known that networks can interconnect with other networks and contain sub-networks. The most common topology or general configurations of networks include the bus, star, and token ring topology. However, these term network can also be characterized in terms of spatial distance, as in local area networks (LAN), metropolitan area networks (MAN), and wide area networks (WAN). A given network can also be characterized by the type of data transmission technology in use on it; by whether it carries voice, data or both kinds of signals; by who can use the network (public or private); by the usual nature of its connections (dial-up or switched, dedicated or non-switched, or virtual connections); and by the types physical links (for example, optical fiber, coaxial cable, ethernet, unshielded twisted pair and satellite). In view of this, the interchangeable terms “network”, “network architecture” and “network infrastructure” should be interpreted as broadly as possible to contemplate any series arrangement of nodes which are interconnected by communication pathways which would permit application of the present invention in any of its various forms. Furthermore, while the present invention, in its preferred form, is implemented on a network architecture which employs an open system protocol, such as the TCP/IP layered protocol suite, as the common communications language between computer systems on the network, it is envisioned that the present invention could also be implemented on other types of open systems, such as the OSI seven-layer model, as well as closed proprietary systems.

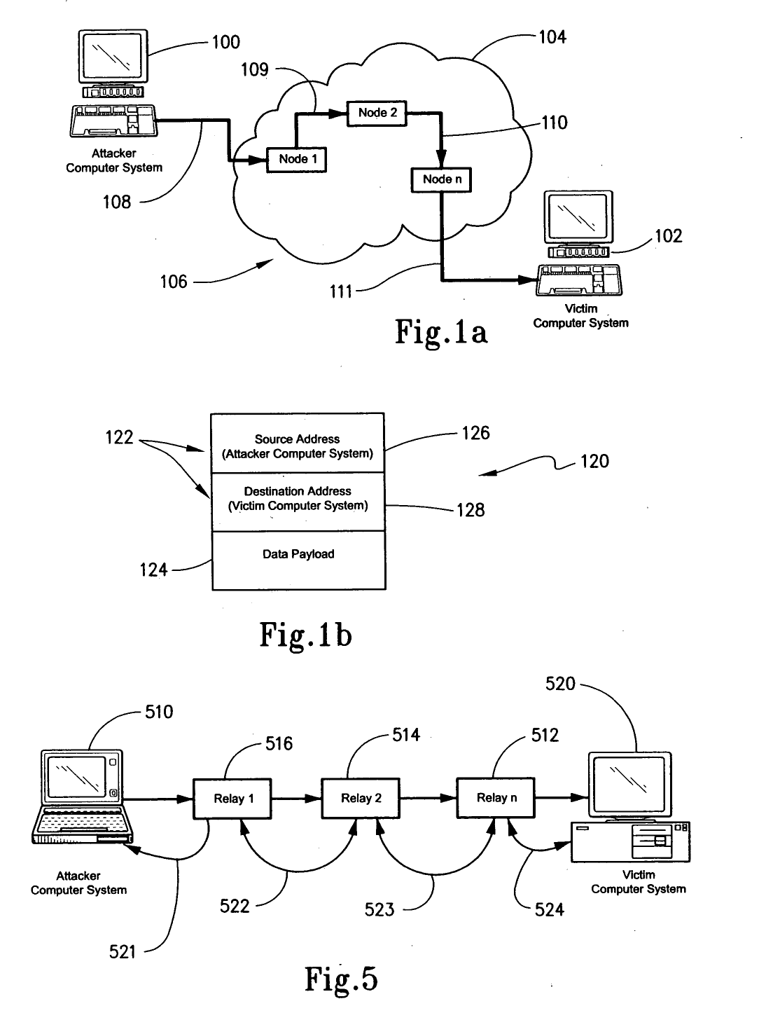

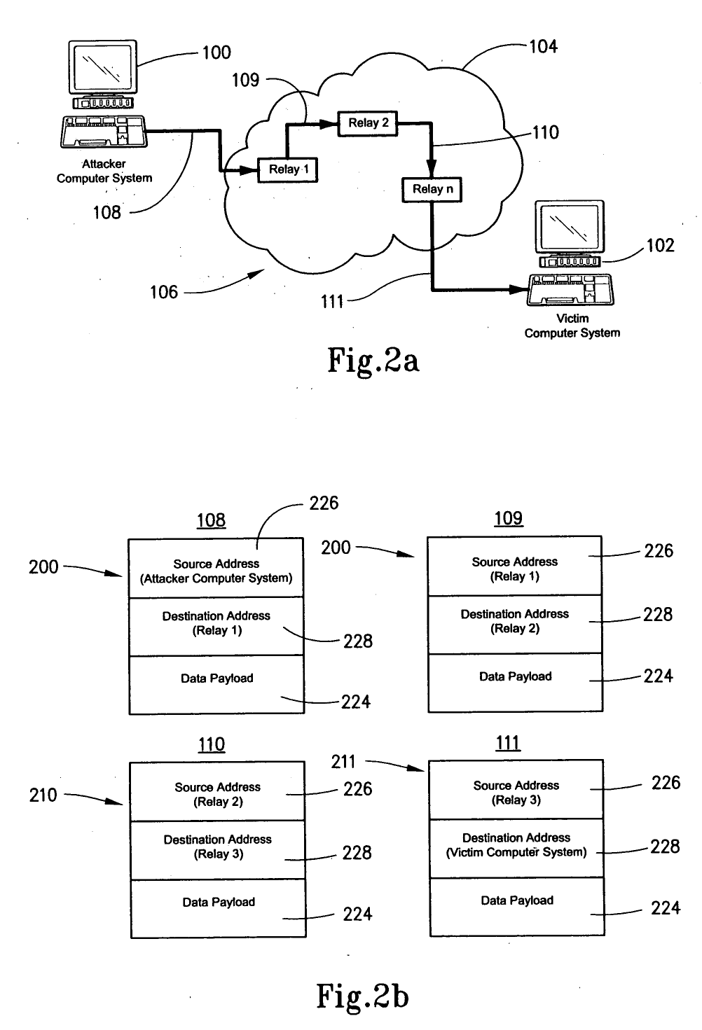

With the above in mind, and by way of introduction, initial reference is made to FIGS. 1(a), 1(b), 2(a) and 2(b) to introduce the environment of the invention in the context of a conventional relay attack. In many situations, when an attacker breaks into a network or a machine and launches various other attacks like e-mail spoofing, the attacker understandably does not what the attack to be traced back to him. This creates an interesting dilemma, since the attacker now has to perform an attack using his computer without being identified. FIG. 1(a) illustrates, diagrammatically, the situation where an attacker launches an attack from an attacker computer system 100 to a victim computer system 102, without attempting to conceal his identity. Here, the attacker computer system 100 interconnects to the victim computer system 102 through a network, such as the global Internet 104, and specifically interconnects through a plurality of nodes to define a communication pathway 106 for the attack. Communication pathway 106 is, thus, comprised of a plurality of individual communication links 108-111 between intermediary nodes 1, 2 . . . n and terminal nodes 100 and 102.

Where the network architecture which provides the basis for the attack on the victim computer system 102 is a packet/switching network, such as the global internet, which permits communication in accordance with the TCP/IP protocol suite, each packet or datagram which is transmitted along a respective communication pathway, such as pathway 106 in FIG. 1(a), has an associated IP header portion 122 and an IP data portion 124. As shown in FIG. 1(b), among the various fields known to be included in an IP packet's header portion 122 is the source address field 126 which identifies the source IP address for the given packet, and the destination address field 128 which identifies the destination IP address of the given IP packet. Of course, the ordinarily skilled artisan would readily understand that FIG. 1(b), for purposes of illustration, only represents pertinent fields associated with a typical IP packet/datagram and that many other common fields (not shown) would also be included.

As can be seen in FIG. 1(b), the identification of the originating source and ultimate destination for the datagram does not change as it traverses the network. As such, the source address field 126 for each packet transmitted identifies the source IP address for the attacker computer system 100, and the destination address field 128 for each transmitted packet identifies the victim computer system's IP address. Each packet has an associated data payload within its data portion 124 which also remains unchanged throughout transmission. Accordingly, it can be appreciated that it would be straightforward for a system administrator to simply sniff the network traffic crossing victim computer system 102 and identify the attacker computer system 100 as the source of the attack since this would be readily identifiable from each packet's source address field.

One way for an attacker to circumvent this is through a relay attack, also known as relaying. The characteristics of relaying are diagrammatically illustrated in FIGS. 2(a) and 2(b). In a relay attack, an attacker relays or bounces his traffic through one or more third party machines so that the attack appears as if it came from the third party, not the actual attacker. This creates difficulty for the victim because it can be exceedingly difficult to identify the attacker. A popular type of relaying attack is e-mail relaying which involves connecting to another individual's e-mail system and using that individual's computer to send e-mail to someone else. To illustrate this, in FIG. 2(a), the attacker again initiates his attack from originating computer system 100 through the global Internet 104 to the ultimate destination computer system 102. Each representative packet likewise travels along an associated communication path, such as communication path 106, which includes individual communication links 108-111. However, the difference in FIG. 2(a) is that the attacker has previously installed relay software, such as Netcat, onto each computer system which resided as a node in FIG. 1, such that each said computer system now serves as a relay node for the surreptitious attack. The result of this pre-established routing set up by the attacker is that now communication pathway 106 represents that traveled by each and every transmitted packet, not just a representative packet as in FIG. 1(a).

Assuming, for example only, that each of Relay 1, Relay 2 . . . Relay n is a computer system in the form of a router on the network infrastructure, installation of suitable relaying software onto each router can dictate the location of the next hop in the pathway regardless of considerations such as network traffic congestion, etc. Typically, a router ensures that all data gets sent to its intended destination via the most efficient route. When an input port on a router receives a packet, normal execution of the stored software routine, called a routing process, is executed which looks inside the header information and the IP packet to find the address to which the data is being sent. It then compares this address against an internal database called a routing table, which may be either static or dynamic, and which contains detailed information about ports to which the packets with various IP addresses should be sent. Relaying software, however, can modify routing tables to, in essence, dictate to the router that when an incoming packet from a particular source IP address is received, it should be forwarded to a particular destination IP address.

Accordingly, FIG. 2(b) represents what happens to the pertinent fields within each IP packet 200 that is transmitted between the attacker computer system 100 and the victim computer system 102 via relay connections. Along communication link 108, each IP packet 200 has its source address field 226 initially identifying that the attacker computer system and its destination address field 228 initially identifying the IP address for Relay 1. Once packet 200 reaches Relay 1 and is subsequently transmitted along communication link 109, its source address now identifies the IP address of Relay 1 and the destination IP address for Relay 2. In similar fashion, along communication link 110 in FIG. 2(a), the source field 226 for each IP packet identifies the IP address for Relay 2 and the destination field 228 identifies the IP address for Relay 3. Finally, as each packet 200 reaches the ultimate destination of victim computer system 102, its source address field identifies the IP address for relay 3 and destination address field identifies the IP address for the victim computer system. Notably, each packet's associated data portion 224 remains unchanged throughout transmission along communication pathway 106, even though the addressing information fields are repeatedly changing at each node which the attacker has pre-established as a relay site. It is these characteristics of a conventional relay attack, i.e. the unchanged characteristics of the underlying message data for a particular packet coupled with the altering characteristics of the addressing information, that can be used to identify candidate relay sites used by attackers.

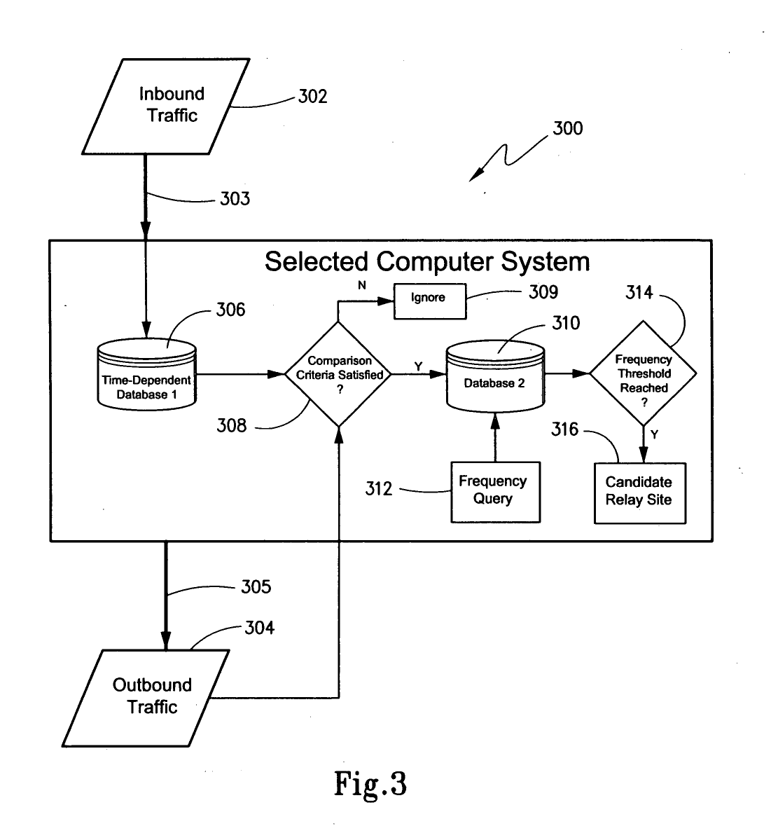

With the above in mind, methodologies will now be discussed with reference to FIG. 3 for determining whether a selected computer system is a candidate relay node used to route network traffic from an origin computer system, such as attacker computer system 100 in FIG. 2(a) to a destination computer system, such as victim computer system 102. The methodologies discussed are preferably performed on a networked computer system 300 as diagrammatically represented in FIG. 3, which networked computer system 300 may be any appropriate node that one either suspects is, or in the future could be, employed as a relay during a relay attack. Again, the selected computer system 300 in FIG. 3 can be any of a variety of appropriate types as discussed above. Further, appropriate software having executable instructions for performing any of the methodologies discussed herein can be stored on a computer-readable medium associated with the selected computer system 300. Depending on the particular type of networked computer system employed, the executable instructions may be located on the system's permanent storage, such as a read only memory (ROM) or a hard drive. Alternatively, the executable instructions can be stored on a removable storage device, such as floppy disk drive, a CD-ROM drive, a DVD-ROM drive, flash memory, a magnetic tape medium, or the like. Test source code for software which accomplishes a methodology of the present invention has been developed on a Unix machine utilizing the Bins-Shell scripting language in conjunction with tcpdump. However, it is believed that appropriate software could be readily adapted for use with other types operating systems, such as Windows or DOS, to name only a few, and it may be written in one of several widely available programming languages with the modules coded as sub-routines, sub-systems, or objects depending on the language chosen. In addition, various low-level languages or assembly languages could be used to provide the syntax for organizing the programming instructions so that they are executable in accordance with any of the embodiments of the description to follow.

With the above in mind, the broad form of the methodology implemented on selected computer system 300 involves comparing the addressing information contained within the associated header portion of each outbound packet that is transmitted by the computer system 300 with the addressing information contained within the associated header portion of each inbound packet, if any, having the same data payload that was previously received by the computer system 300 during a preceding interval of time. If this comparison satisfies established criteria with a selected frequency of recurrence, then the computer system 300 is identifiable as a candidate relay site.

In an exemplary form of this broad methodology, the selected computer system 300 resides as a node on a network architecture which transmits network traffic in the form of a stream of packets between origin and destination computer systems and along communication pathways according to the TCP/IP protocol suite. As such, each packet necessarily includes a header portions and a data portion as discussed above with. Inbound traffic 302 is received by computer system 300 along one or more input channels, such as channel 303, and can be monitored with an appropriate sniffer program such as tcpdump, windump, ethereal, sniffit, to name a few. Similarly, outbound network traffic 304 transmitted along one or more channels, such as channel 305, can also be monitored with an appropriate sniffer. Computer system 300 includes a network interface (not depicted) for controlling an exchange of data between it an other nodes on the network. A first memory region, preferably a time-dependent first database 306, is located on computer system 300 for the purpose of storing inbound traffic 302. Minimally, first database 306 stores the associated data payload for each inbound packet as well information contained within the source and destination address fields of the packet's IP header. In a non-relaying situation the source address field would identify the originating computer system, whereas in a relaying situation the source address field would identify a predecessor relay node (if computer system 300 is not the first relay node in the chain) or an attacker's computer system (if computer system 300 is either the first or only relay node employed). The destination address field would identify either the IP address for computer system 300 is a relaying situation, or the IP address of the ultimate destination computer system in a non-relaying scenario. In any event, the source address field of each inbound packet would necessarily identify a predecessor node in the communication pathway and the destination address field would identify a successor node. Preferably database 306 only maintains this information for a selected storage period, which may be determined by the type of computer system employed. For most systems, though, it is believed that a three (3) minute storage period is sufficient.

As explained above, a distinguishing characteristic of a relay attack is the fact that, during those periods when a computer system is being used as relay node, outbound packets transmitted by the system have respective data portions identical to previously received inbound packets, but different IP addressing fields. Accordingly, for each outbound packet that is transmitted by computer system 300, a comparison 308 can be made to compare characteristics of the outbound packet to appropriate characteristics of previously received inbound packets to ascertain if there is an indication that relaying is occurring. Different types of comparison criteria could be employed. For example, if it is determined that the addressing information contained within the associated header portion of a respective outbound packet does not match the addressing information for a previously received inbound packet within first database 306 having the same payload, then this absence of a match would satisfy the comparison criteria at 308. In such a situation, an event log is stored in a second memory region of computer system 300, namely second database 310. Under a second type of comparison criteria, the inquiry at 308 could particularly compare the source IP address of each outbound packet with the destination IP address of each previously received inbound packet within first database 306 to ascertain an existence or absence of a match therebetween. This second type of comparison criteria would, thus, be satisfied, and thereby raise an indication that the selected computer system 300 is used as a relay, if a match does exist. Accordingly, an event log would then also be stored in second database 310 to identify this occurrence. Of course, if the comparison criteria at 308 is not satisfied then the information contained within the respective outbound packet is simply ignored at 309.

Second database 310 can then be periodically queried at 312 via an SQL script of the like to ascertain if there is a recurring correlation between event logs in the database to indicate that the networked computer system 300 is being used to repeatedly forward inbound network traffic from a particular predecessor node to a particular successor node. If the frequency query 312 of the second database 310 ascertains that such a correlation has recurred for a selected frequency threshold, then the response to a inquiry at 314 indicates at 316 that the selected computer system is a candidate relay site.

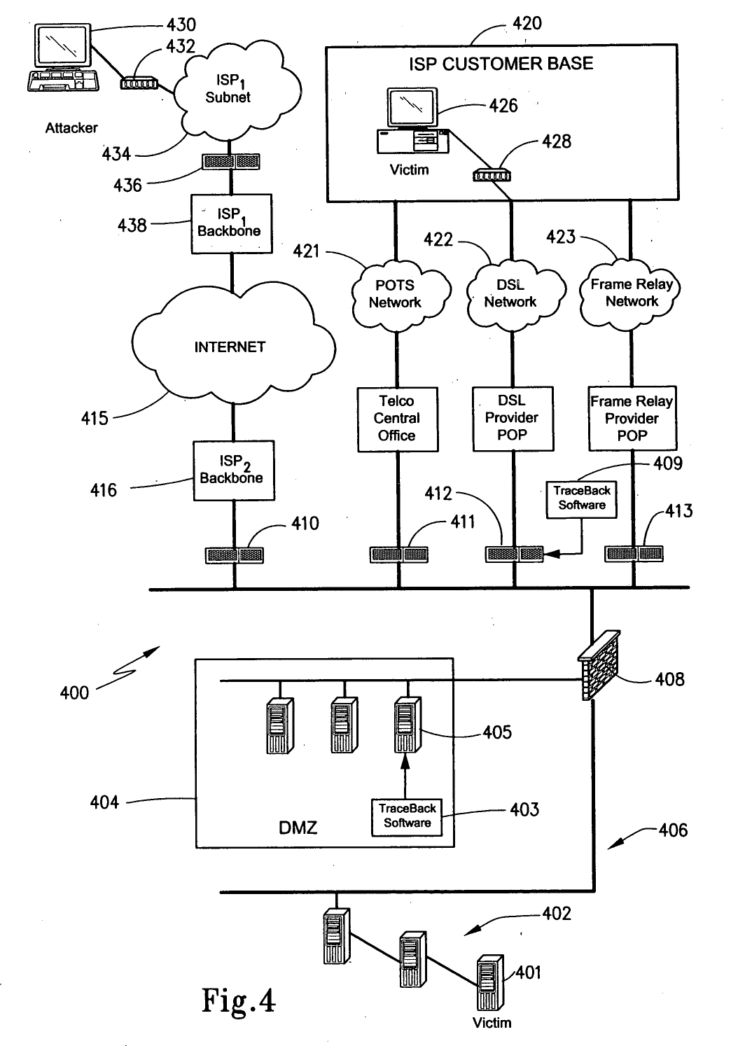

Reference is now made to FIG. 4 to illustrate, for representative purposes only, how the concepts of the present invention can be implemented on a representative network for an internet service provider (ISP) that is connected to the Internet. Here, the ISP's network infrastructure includes a plurality of secure servers 402 used for internal ISP administration, such as private mail, etc. The ISP's internal network also includes a demilitarized zone (DMZ) 404 which might include web servers, e-mail servers or other devices that must be freely available on the Internet. The ISP's internal corporate network 406 is shielded by a firewall represented as 408. Routers 410-413 couple the ISP's internal network 406 to its customer base and the Internet. More particularly, router 410 couples internal network 406 to the Internet 415 via an ISP backbone 416. Routers 411-413, respectively interface the internal corporate network 406 to the ISP's customer base 420 via respective, dedicated networks, such as POTS network 421, DSL network 422 or frame relay network 423. Also shown as part of the ISP's customer base 420 is a representative computer 426 for a DSL customer interconnected to the DSL network 422 via modem 428. Appropriate software, identified as “trace back software” having computer executable instructions for implementing appropriate methodologies according to the present invention are stored at strategic locations throughout the ISP infrastructure 400. For example, software 403 is stored on one of the servers 405 within DMZ 404, and software 409 is also stored on router 412. Appropriate software embodying the present invention may be distributed in known manners, such as on a computer-readable medium or over an appropriate communications interface, so that it can be installed on these systems. As also shown in FIG. 4, an attacker's computer system 430 is connected, via modem 432, to another ISP subnet generically represented at 434. ISP subnet 434 is interfaced with the global internet 415 via an associated router 436 and ISP backbone 438.

If attacker 430 implements a relay attack against ISP customer 426 and utilizes at least router 412 as a relay point for the attack, the provision of the trace back software 409 on router 412 would detect such an attack. The software would then identify any predecessor relay point or successor relay point in the communication link which the attacker has pre-established for implementing the relay attack. If any other relay nodes are used by attacker 430 in the chain, they could be other systems owned by the ISP or third party systems. In any event, an ISP administrator could make appropriate inquires and implement measures to have appropriate trace back software installed on any such predecessor or successor node(s), and the detection process could be repeated with respect to each such node until, eventually, the attacker's computer system 430 is identified as the origination point for the relay attack.

FIG. 4 also illustrates how the trace back features of the present invention could be implemented in the internal corporate internet 406 for the ISP, thereby providing the ability to detect an attack on one of the ISP's secure servers, such as victim server 401. If the attacker 430 implements the relay attack of victim computer system 401 by utilizing server 405 as a relay node, then this could also be detected. Assuming, for purposes of illustration, that server 405 is a web server, it necessarily is not intended to initiate any connection requests to other computer systems since it functions as a host system. However, if the attacker has previously infiltrated the ISP's firewall 408 and installed relay software on server 405, then when the server is utilized as a relay node it would necessarily initiate an outgoing connection. The trace back software 403 could be set up to monitor such network traffic and raise an alert in the event an appropriate sniffer detects outgoing connection requests. Accordingly, when the present invention is employed on a dedicated host computer system, such as a web server, that is not intended to initiate connection requests, the software's executable instructions can cause the network traffic associated with the host computer system to be sniffed during a selected monitoring period. A frequency, if any, can then be ascertained at which the host computer system initiates connection requests to another computer system on the network architecture. In the event the detected frequency exceeds a pre-determined threshold, which can be appropriately established according to administrator's own preferences, an output device can be controlled to display associated output indicative of the host computer system being used as a candidate relay site.

Although not illustrated in FIG. 4, the reverse also holds true if the present invention is implemented on a dedicated client computer system, such as a desktop machine. In this situation, a similar methodology can be implemented to determine whether the dedicated client computer system is a candidate relay site. In such a situation, however, the computer executable instructions would sniff the network traffic associated with the client computer system and ascertain a frequency, if any, at which the client computer system receives connection requests from another computer system on the network architecture. Receipt of connection requests would be indicative of the client computer system being used as a candidate relay node since desktop computers are intended to initiate connection requests, not receive them. Accordingly, the methodology discussed above with reference to FIG. 3 which works on any appropriate system, irrespective of its particular function as a client, host or both, can be appropriately tailored to a selected computer system which is a dedicated host or dedicated client.

With an appreciation of the above, reference is now made to the diagrammatic view of FIG. 5 to illustrate one methodology by which each of a plurality of relay sites used during a relay attack can be identified in accordance with the invention. FIG. 5 illustrates a relay attack which involves “n” relay nodes for the attack, where “n” can be any integer which corresponds to the total number of relay nodes used during the attack. In the representative example described below, however, it will be assumed that there are only three (3) such relay nodes so that “n” equals 3. If one suspects that a particular computer system is being infiltrated, or may used as a relay point for infiltrating another system, then trace back software can be installed on it to monitor inbound and outbound network traffic.

Initially, then, a first computer system of interest is identified which resides on the network, such as a computer system 512. System 512 might be identified because an administrator monitoring logs on another computer system 520 notices suspicious activity originating from the IP address associated with system 512. Unbeknownst to the administrator at the time is that computer system 512 is actually a terminal, nth relay used by an attacker operating computer system 510 in a relay attack on victim system 520. Monitoring the inbound and outbound traffic associated with system 512 in accordance with the present invention would, however, reveal that inbound network traffic received by system 512 from a predecessor computer system 514 is regularly forwarded to a successor node, namely system 520. This being the case, computer system 512 is identified as a candidate relay site, and predecessor computer system 514 is identified as a next computer system of interest. Software could then be installed on system 514 to monitor its inbound and outbound network traffic. In the case of system 514, the trace back would expectedly identify computer system 512 as a successor relay node, but would now additionally identify a new predecessor computer system 516. There would, of course, be no need to monitor inbound and outbound network traffic associated with computer system 514 as it was previously identified. However, network traffic can now be monitored with respect to computer system 516 which would ultimately identify the IP address of the attacker's computer system 510, which is the originating source of the relay attack.

It should be appreciated that FIG. 5 is only representative of one scenario by which the attacker's computer system might be identified. Indeed, it is contemplated that software in accordance with the invention could be installed as a preventive measure on any appropriate computer system on network, and does not have to be installed in response to the detection of suspicious activity. So, for example, by initially installing the software on computer system 514 in FIG. 5, each other relay node in the attack could be identified which ultimately lead to a finding that system 520 is the victim of a relay attack from attacker system 510. Bi-directional arrows 521-524 illustrate this versatility.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

What is claimed is:

1. A computerized method for determining whether a selected computer system is a candidate relay node used to route network traffic from an origin computer system to a destination computer system, wherein said network traffic comprises a stream of packets each having an associated header portion which contains addressing information for the respective packet, and a data portion which includes a data payload, said computerized method comprising:
comparing the addressing information contained within the associated header portion of each respective outbound packet that is transmitted by the selected computer system with the addressing information contained within the associated header portion of each inbound packet, if any, having the same data payload that was previously received by the selected computer system during a preceding interval of time, thereby to determine an existence or absence of a match therebetween; and
identifying the selected computer system as said candidate relay node if an absence of said match occurs with a selected threshold frequency.

2. A computerized method according to claim 1 wherein said preceding interval of time is at least a three (3) minute period immediately preceding transmission of the respective outbound packet.

3. A computerized method according to claim 1 wherein the header portion of each inbound and outbound packet includes a source field that identifies an associated source address for the packet, and a destination field that identifies an associated destination address for the packet, and whereby the associated source address of each respective outbound packet is compared with the associated destination address of each said inbound packet to determine existence or absence of said match therebetween.

4. A computerized method for determining whether a selected computer system residing as a node on a network architecture serves as a relay for routing network traffic from an origin computer system to a destination computer system, wherein said network traffic comprises a stream of packets each routed between the origin and destination computer systems along an associated communication pathway according to a TCP/IP protocol suite, and wherein each packet includes an associated header portion having a source field that identifies a source IP address for a predecessor node in the associated communication pathway, a destination field that identifies a destination IP address for a successor node in the associated communication pathway, and an associated data portion having a data payload for transmission from the origin computer system to the destination computer system, said computerized method comprising:
monitoring inbound packets received by the selected computer system and outbound packets transmitted by the selected computer system;
storing the associated header portion and data portion for each inbound packet received by the selected computer system into a first memory region for a selected storage period, thereby to generate a time-dependent compilation of inbound packet data;
with respect to each of a plurality of outbound packets transmitted by the selected computer system:
comparing the source IP address of each outbound packet with the destination IP address of with each inbound data packet which was previously received by the selected computer system during said storage period and which had an identical data payload, thereby to ascertain an existence or absence of a match therebetween;
storing, into a second memory region, a corresponding event log each time an absence of said match is ascertained; and
identifying the selected computer system as a candidate relay if an absence of said match occurs with a selected frequency.

5. A method according to claim 4 whereby a sniffer program is used for monitoring the inbound packets received by the computer system and the outbound packets transmitted by the computer system.

6. A method according to claim 5 wherein said sniffer program is selected from a group consisting of tcpdump, windump, ethereal and sniffit.

7. A method according to claim 4 wherein said first memory region is defined by a first database residing on the selected computer system, and wherein said second memory region is defined by a second database residing on the selected computer system.

8. A method according to 7 whereby ascertaining existence or absence of said match is accomplished by executing a first SQL script against said first database.

9. A method according to claim 8 whereby ascertaining if an absence of said match occurs with a selected frequency is accomplished by executing a second SQL script against said second database.

10. A method according to claim 4 whereby the selected storage period for each inbound packet is at least three (3) minutes.

11. A method of identifying relay sites used by an attacker during a relay attack for the purpose of routing network traffic between an attacking computer system and a victim computer system, said method comprising:
a. identifying a first computer system of interest that resides on a network architecture;
b. monitoring inbound and outbound network traffic associated with the selected computer system of interest to ascertain a frequency at which inbound network traffic received by the computer system of interest from a particular predecessor computer system, residing at an associated source address, is subsequently transmitted by the computer system of interest to a particular successor computer system, residing at an associated destination address;
c. identifying said computer system of interest as a candidate relay site, and identifying each of said predecessor computer system and said successor computer system as a next selected computer system of interest, if said frequency exceeds a predetermined threshold;
d. repeating steps (b) and (c) for each newly identified predecessor and successor computer system.

12. A computer-readable medium having executable instructions for performing a method comprising:
monitoring inbound and outbound network traffic associated with a networked computer system;
comparing outbound network traffic that is transmitted by the networked computer system to inbound network traffic previously received by the networked computer system in order to ascertain if there is a recurring correlation therebetween which indicates that the networked computer system is used to repeatedly forward inbound network traffic from a particular predecessor node on a network architecture to a particular successor node on the network architecture; and
controlling an output device to display output indicative of the networked computer system being a candidate relay site for use in routing network traffic between an origin computer system and destination computer system, if said correlation recurs with a selected frequency.

13. A computer readable medium according to claim 12 wherein the executable instructions are operative to store inbound network traffic in a first memory region of the networked computer system for a selected storage period.

14. A computer readable medium according to claim 13 wherein the executable instructions are operative to store an event log in a second memory region of the networked computer system each time a correlation is ascertained, and to query the second memory region according to a selected querying script in order to ascertain if said correlation recurs with the selected frequency.

15. A monitoring system for ascertaining relay nodes used for routing network traffic from an origin computer system to a destination computer system, said system comprising:
a storage device;
an output device;
a network interface; and
a processor programmed to:
monitor inbound and outbound network traffic associated with the network interface;
compare outbound network traffic transmitted past the network interface to inbound network traffic previously received at the network interface in order to ascertain if there is a recurring correlation therebetween which indicates that inbound network traffic from a particular predecessor node located upstream of the network interface in a communication pathway is repeatedly forwarded to a particular successor node located downstream of the network interface; and
control an output device to display associated output if said correlation recurs with a selected frequency.

16. A monitoring system for ascertaining relay nodes used for routing network traffic from an origin computer system to a destination computer system, said apparatus comprising:
storage means;
output means; and
processing means for:
monitoring inbound and outbound network traffic associated with a networked computer system;
comparing outbound network traffic transmitted past the network interface to inbound network traffic previously received at the network interface in order to ascertain if there is a recurring correlation therebetween which indicates that inbound network traffic from a particular predecessor node located upstream of the network interface in a communication pathway is repeatedly forwarded to a particular successor node located downstream of the network interface; and
controlling an output device to display associated output if said correlation recurs with a selected frequency.

17. A method of determining whether a dedicated client computer system which resides as a node on a network architecture is used as a relay for routing network traffic between an attacking computer system operated by a hacker and a victim computer system, said method comprising:
storing onto the client computer system computer-executable instructions for:
sniffing network traffic associated with the client computer system during a selected monitoring period;
ascertaining a frequency, if any, at which the client computer system receives connection requests from another computer system on the network architecture; and
controlling an output device to display associated output if said frequency exceeds a predetermined threshold frequency.

18. A method of determining whether a dedicated host computer system which resides as a node on a network architecture is used as a relay for routing network traffic between an attacking computer system operated by a hacker and a victim computer system, said method comprising:
storing onto the host computer system computer executable instructions for:
sniffing network traffic associated with the host computer system during a selected monitoring period;
ascertaining a frequency, if any, at which the host computer system initiates connection requests to another computer system on the network architecture; and
controlling an output device to display associated output if said frequency exceeds a predetermined threshold frequency.
